(19) United States
(12) Patent Application Publication
(10) Pub. No.: US 2025/0314334 A1
(43) Pub. Date: Oct. 9, 2025

(54) PRODUCTION OF A PIPE WITH A FUNCTIONAL LAYER ON A CORE AND A PIPE

(71) Applicant: Diehl Aviation Laupheim GmbH, Laupheim (DE)

(72) Inventors: Dirk Pfinder, Balzheim (DE); Fabian Ade, Bad Waldsee (DE); Michael Denzel, Oberstetten (DE); Marco-Reyes Janke, Neu-Ulm (DE); Peter Steinmayer, Schwendi (DE); Nicolas Lamp, Achstetten (DE); Markus Klingseis, Biberach (DE)

(21) Appl. No.: 19/096,934

(22) Filed: Apr. 1, 2025

(30) Foreign Application Priority Data
Apr. 9, 2024 (DE) 10 2024 109 800.7

(51) Int. Cl. F16L 9/147; B29C 53/56; B29C 61/02; B29C 70/44; B29C 70/68; B29L 23/00

(52) U.S. Cl. CPC F16L 9/147; B29C 53/566; B29C 61/025; B29C 70/446; B29C 70/682; B29L 2023/22

(57) ABSTRACT

For producing a pipe, a core is provided and a functional material, a fiber composite material and a shrink material forming a shrink tube are applied radially externally to the core. The pipe is thermoformed by heating of the pipe with application of radially inward pressure to the fiber composite material and radially outward pressure to the functional material, this in turn by radially inward thermal contraction of the shrink tube and/or radially outward thermal expansion of the core. At the same time consolidation of the functional material together with the fiber composite material form the pipe, and cooling to a cold temperature and demolding of the consolidated pipe from the shrink tube and from the core. The functional material has such a media resistance with respect to the medium that for a planned usage period it is less damaged by the medium than the fiber composite material.

### CROSS-REFERENCE TO RELATED APPLICATION

This application claims the priority, under 35 U.S.C. § 119, of German Patent Application DE 10 2024 109 800.7, filed Apr. 9, 2024; the prior application is herewith incorporated by reference in its entirety.

### FIELD AND BACKGROUND OF THE INVENTION

The invention relates to a pipe composed of a fiber composite material and to production thereof.

Published, non-prosecuted German patent application DE 10 2012 013 289 A1 discloses a production process for a ventilation or air-conditioning pipe wherein a pipe body of the pipe is produced from a curable fiber composite material. In the course of the curing of the fiber composite material, an inner face of a first annular segment of the pipe body is pressed, with application of pressure from externally, against an outer face of a mandrel introduced into the first annular segment. In addition, a second annular segment of the pipe body is pressed, with application of pressure from internally, against an inner face of a tool encircling at least the second annular segment.

### SUMMARY OF THE INVENTION

It is an object of the present invention to specify improvements in relation to a pipe composed of a fiber composite material and to production thereof.

The object of the invention is achieved through a process according to the independent process claim. Preferred or advantageous embodiments of the invention and also different categories of invention are apparent from the further claims, the description hereinafter, and the appended figures.

The process serves for producing a pipe. A pipe as follows is produced in this process: a description is given here of the pipe as it is intended to be in the fully completed state or fabrication state, i.e. after conclusion of the production process. The pipe extends along a central longitudinal axis in the form of a straight line. The pipe contains a tubular main body. The main body is produced from a fiber composite material or comprises such a material. The main body has a radially inner or inward-facing inside.

At its inside, the main body is connected firmly to a tubular functional layer. The functional layer is produced from a functional material or comprises such a material. The main body thus surrounds the functional layer. In other words, the main body and functional layer form two mutually connected part-pipes which run concentrically with one another and are connected to give the overall pipe. An outside of the functional layer thus bears against the inside of the main body and is connected to it (optionally with interposition of a metal layer, part of the functional layer or functional material). The functional layer and therefore the overall pipe surrounds a pipe interior situated internally in the pipe. Here, an inner wall of the functional layer or of the pipe faces radially inward. The functional layer is optionally further provided, radially internally, with a metallization/metal layer, and so strictly speaking the latter then forms the inner wall. The metal layer is understood presently to be part of the functional layer.

In its fabrication state, i.e. when the pipe produced is fully completed, it is intended to accommodate, thus to carry or to hold, a defined medium in its interior during operation of the pipe. The medium is in particular a fluid, more particularly a coolant for a fuel cell or hydrogen of a fuel cell. In the fabrication state, all the constituents of the pipe, especially the fiber composite material and the functional material, are in their fully completed final state and at least in that state have corresponding physical properties.

The process includes the now described steps.

First, a core is provided. The core as well extends along the central longitudinal axis. The core constitutes a fabrication means for the pipe and is implemented in particular in the manner of a straight cylinder (more particularly a circular cylinder). An outer wall of the core forms a bearing face for the inner wall of the pipe. During production, then, the pipe to be fabricated and/or components thereof (functional material, fiber composite material, etc.) is placed extensively by its (later) inner wall against the outer wall of the core.

The functional material is subsequently applied radially externally to the core. In the later fabrication state, the functional material then forms the functional layer.

The fiber composite material is subsequently applied radially externally to the functional material. In the fabrication state, the fiber composite material forms the main body.

A shrink material is subsequently applied radially externally to the fiber composite material. At least in the course of the process, a shrink tube is formed from the shrink material (or the shrink material on application is already a completed shrink tube).

Hence the base construction, not yet fully completed, of the pipe on the core has been made ready and is surrounded by a shrink material.

In further process steps, the pipe is then thermoformed. This takes place as follows.

First, a core, functional material, fiber composite material and a shrink material are heated to a hot temperature. In the course of the heating, pressure is applied by functional material and fiber composite material against one another in radial direction (relative to the central longitudinal axis). In other words, the functional material is pressed radially outwardly and the fiber composite material radially inwardly against one another or onto one another. This is accomplished by means of two measures: first, by radially inward pressure to the fiber composite material. The pressure is caused by a radially inward thermal contraction of the shrink tube. Second, pressure is applied radially outwardly to the functional material. This is caused by a radially outward thermal expansion of the core. The contractions of shrink tube and/or core take place either in unison or only individually. One possibility therefore is, for example, to combine a core which expands on heating with a shape-immutable, non-contracting pressure tube.

The radially inward and/or outward pressure exerted on fiber composite material and functional material against one another results in consolidation of the functional material together with the fiber composite material to define the pipe.

Subsequently, all the components (shrink tube, pipe, core) are cooled to a cold temperature and the consolidated pipe is demolded from the shrink tube and from the core. This takes place non-destructively in relation to the core in particular. The shrink tube for its part may be removed here either non-destructively or by destruction.

In the process, the functional material is selected such that at least in the fabrication state of the pipe, the material is media-resistant with respect to the medium to be accommodated in the intended manner in the pipe as elucidated above. The “media resistance” is achieved in that or to be understood to mean that the functional material is less damaged by the medium, at least for a planned usage period, than the fiber composite material would (hypothetically) be damaged were the fiber composite material to be exposed instead of the functional material, or without its protection, equally to the medium. The “damage” here is to be understood as an attack on the/impairment of properties of the materials in question, so that they then, for example, no longer adequately meet a given requirement for media resistance, such as a required imperviousness or diffusion rate in respect of the medium, for example. Also possible, for example, is a comparison between the degree of material erosion on the functional material or functional layer and such erosion (hypothetical) on the fiber composite material.

The medium is, in particular, a fluid, especially a coolant or hydrogen, more particularly of a fuel cell or a fuel cell arrangement (including cooling circuit, media inlet and outlet).

In accordance with the invention, a sufficiently media-impervious, media-carrying pipe is produced, having a functional layer of fiber composite material, by way of a core, and the corresponding pipe. A functional layer is integrated into a pipe as a direct part of the producer operation for the pipe.

In one preferred embodiment, on radially external application to the core, the functional material is already in the form of a completed functional tube. In that case, in particular, the functional material is shaped, welded or directly extruded to form a tube in an upstream operation (i.e. upstream of the production of the pipe). The functional material can therefore be processed particularly easily in the process—specifically, a functional layer (in the unprocessed state, i.e. prior to final completion) can simply be pulled as a tube over the core.

In an embodiment alternative to this, the functional material is applied radially externally to the core by being wound onto the core. The functional material here may be present/wound in particular as a tape or cloth material. After winding, therefore, the functional material (in the unprocessed state, i.e. prior to final completion) does not yet form a continuous layer on the core like the abovementioned functional tube in the form of a continuous single-piece tube/part-pipe. A part-pipe of this kind in the form of the functional layer is then completed only as part of the thermoforming, specifically when the winding is completed to form the actual functional layer. According to this embodiment, the functional material can simply be applied to the core, thereby avoiding possibly inconvenient pulling of a tube over the core.

In one preferred embodiment, the fiber composite material is applied radially externally to the functional material (already applied on the core) by being laminated over or wound round. Here as well, the wound or laminated fiber composite material initially does not yet form a continuous layer (main body, part-pipe). This layer too is formed only as part of the thermoforming. The statements made with regard to the functional material above are hereby also valid, mutatis mutandis, for the fiber composite material.

In one preferred embodiment, the shrink material is applied radially externally to the fiber composite material (already applied to the core and to the functional material) by being wound round. The shrink material is provided here in particular as a tape (known as “heat shrink tape”). Here as well, the above statements with regard to the winding of fiber composite material or functional material are valid, mutatis mutandis.

In one preferred embodiment, the core provided comprises a core which in relation to its outer wall, i.e. its outside diameter/radial extent/dimensions in relation to the central longitudinal axis, has a greater radial thermal contraction between hot temperature and cold temperature than the pipe (its inside diameter/radial extent or dimensions). As a result of this, on cooling from the hot temperature to the cold temperature, the core or its outer wall undergoes greater radially inward contraction than the pipe or its inner wall. Accordingly, the pipe can be demolded particularly easily from the core without or through fewer additional measures such as, for example, a (relatively small) extraction bevel/conicity at the core in the axial direction of the central longitudinal axis.

In one preferred embodiment, during the production of the pipe, a metal layer/metallic blocking layer (tubular) as part of the functional layer is introduced into the pipe. Alternatively or additionally to this, before, during or after the production of the pipe, the functional layer is metallized, i.e. provided with a corresponding metal layer. In particular, the functional layer is metallic coated, especially its inner wall, more particularly after the removal of the pipe completed to this point from the core, to form the metal layer. The metal layer/metallic blocking layer/metallization/metallic coating leads to an increase in the imperviousness or sealing quality of the pipe produced, and/or to a reduction in, more particularly prevention of, permeation and/or ion exchange between interior and surroundings of the pipe. As a result, the pipe acquires an addition to or increase in media resistance.

The object of the invention is also achieved through a pipe according to the independent pipe claim.

The pipe is a pipe produced by means of the process of the invention as elucidated above. The pipe therefore extends along the central longitudinal axis. The pipe contains the tubular main body (part-pipe) composed of the fiber composite material. This main body on its inside is firmly connected to the tubular functional layer (part-pipe) composed of the functional material (its outside). The functional layer with its inner wall (or the wall of the pipe) surrounds the interior of the pipe. The pipe is intended to accommodate a defined medium in its interior in usage or operation in the intended manner.

“In the intended manner” means that the pipe is constructionally tailored to a defined medium or defined type of medium and equipped for usage accordingly, being designed, for example, for the geometric/physical and systemic requirements, etc., that are defined as a result. In other words, in particular, a relevant medium is considered to be known in respect of its physical properties, etc.

The functional material is consolidated together with the fiber composite material to give the pipe (the main body and the functional layer). The functional material is selected such that at least in the fabrication state of the pipe it has such media resistance with respect to the medium that at least for a planned usage period it is less damaged, or less damaged after the usage period, by the medium than the fiber composite material would hypothetically be, or would be after the usage period, if the material were to be equally exposed to the medium.

The pipe and at least some of its possible embodiments, and also the respective advantages, have already been elucidated, mutatis mutandis, in connection with the process of the invention. In particular, therefore, the variants of the pipe stated above in connection with the process constitute its preferred embodiments.

In one preferred embodiment, the pipe is a pipe which in operation carries coolant as a medium in the cooling circuit of a fuel cell. Alternatively the pipe is a pipe which in operation in the intended manner carries hydrogen of the fuel cell as a medium. In other words, the pipe is a part in the intended manner of a fuel cell arrangement which comprises the fuel cell and also ancillary components of said cell, such as sub-arrangements for the supply/withdrawal of medium/cooling, for example.

The invention is based on findings, observations and/or considerations below and additionally contains the following preferred embodiments. In some cases, these embodiments are referred to for simplification as “the invention”. The embodiments here may also comprise or correspond to parts or combinations of the above-stated embodiments and/or may also include embodiments not mentioned so far.

In accordance with the invention, a pipe is produced, having a functional layer, and production thereof by way of a core is provided. A functional layer, more particularly a thermoplastic and/or metallic functional layer, is integrated into a media-carrying (more particularly fluid such as hydrogen or cooling medium as the medium) pipe as a direct part of the production operation. Production takes place by way of a core.

The invention is based on the idea of developing a coolant pipe (carrying coolant as the medium) in the cooling circuit of a fuel cell and developing a hydrogen pipe (carrying hydrogen) for the fuel cell.

The invention is based on the observation from practice that coolant pipes/hydrogen pipes of these kinds are produced from metal, especially stainless steel.

In accordance with the invention, the integration of a functional layer, more particularly a thermoplastic and/or metallic functional layer, into a fiber composite pipe (main body) as a direct part of the production operation ensures the imperviousness and media resistance of the pipe.

The outcome is a low weight of the pipe and also a more rapid production operation. It is possible to achieve a very smooth surface at the inside of the pipe (inner wall). Automated or partially automated manufacture of the pipe is possible. In accordance with the invention, thin-walled pipes without an extraction bevel can be produced. Permeation values in the case of hydrogen are good. Resultant fiber composite pipes are impervious, lightweight and media-resistant.

Achievements are impervious, fluid-carrying pipes of fiber composite material and also the integration of a functional layer as a direct part of the production operation. An outcome is the combination of a pipe structure which is thermoset in particular with a functional layer which is in particular thermoplastic and/or metallic. An outcome is a smooth inside face (inner wall) at the pipe and therefore low flow losses in the pipe. In accordance with the invention, thin-walled, fiber-reinforced pipes without a demolding bevel can be produced. A resultant fiber composite pipe has good permeation values in the case of hydrogen.

The functional layer is in particular a thermoplastic functional layer. Candidate plastics here include, in particular, those which have an appropriate media resistance and which are situated above the usage temperature of the pipe but are formable within the operating temperature for the production of the pipe (hot temperature) of around 100 to 160° C., such as, for example, PP (polypropylene), PVF (polyvinyl fluoride, the product “Tedlar” from DuPont), PVDF (polyvinylidene fluoride) and others. Here, in particular, the functional material is shaped, welded or directly extruded to give a tube in an upstream operation (i.e. upstream of the production of the pipe). Alternatively, this functional layer (functional material) may also be wound around the core and connected in the production operation (heating, consolidation, radial pressure) to give a pipe body (functional layer). This functional layer (functional material) is mounted/pulled over the core and subsequently, for example, cyanate, ester, epoxy or phenolic prepregs (fiber composite material) are laminated over or wound round the core. To obtain the necessary pressure during the curing operation (heating), the entire assembly (core, functional material, fiber composite material) is wrapped again with a corresponding shrink tape (“heat shrink tape”, shrink material in tape form).

The core consists in particular, entirely or partially, of a plastic which possesses appropriate temperature stability, but at the same time also possesses a high coefficient of thermal expansion. As a result, the extent of the contraction of the core on cooling from the operating temperature (hot temperature) to the ambient temperature (cold temperature) is such that it can be extracted without or with only a small extraction bevel. Furthermore, the core material is notable in particular for good slip properties and hardness. A candidate material here, for example, is POM (polyoxymethylene), PTFE (polytetrafluoroethylene) or PVDF. The inner layer (functional material), which more particularly is thermoplastic, connects during the curing operation (heating and radial pressure) to the fiber composite structure (fiber composite material) and remains as a functional layer in the pipe. The core is constructed in particular of plastic with a reinforcement of metal in the inside to improve the dimensional stability.

Authoritative advantages of the functional layer here are the media resistance, imperviousness and diffusion barrier layer for ions. Moreover, an integrated metal foil or metallization of the functional layer very largely prohibits hydrogen leakage/permeation. The stated producer process results in pipes with a very smooth inside face and in pipes with dimensional integrity: in particular, the inside diameter is independent of the thickness of the fiber composite (radial thickness of the main body).

Other features which are considered as characteristic for the invention are set forth in the appended claims.

Although the invention is illustrated and described herein as embodied in the production of a pipe with a functional layer on a core, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an exploded, cross-sectional view of a pipe during its production with a core and a shrink tube;

FIG. 2 is a perspective view of a provision of the core in the production process;

FIG. 3 is a perspective view of an application of the functional material, metal layer and fiber composite material;

FIG. 4 is a perspective view of the application of a shrink material and the fabrication of the pipe in an oven in a schematic sectional representation;

FIG. 5 is a perspective view of the pipes taken out of the oven, with the core and the shrink tube;

FIG. 6 is a perspective view showing a demolding of the pipe from the core; and

FIG. 7 is a perspective view showing metallization of the pipe, completed to this point.

### DETAILED DESCRIPTION OF THE INVENTION

Referring now to the figures of the drawings in detail and first, particularly to FIG. 1 thereof, there is shown a pipe 2 of the invention during its production in an exploded representation in cross-section. The pipe 2 extends along a central longitudinal axis 4 in the form of a straight line. In FIG. 1, the central longitudinal axis 4 is perpendicular to the plane of the page. The pipe 2 radially internally (reference always to the central longitudinal axis 4) contains a tubular functional layer 6 composed of functional material 8. Radially outwardly, the functional layer 6 is surrounded by a tubular main body 10 composed of a fiber composite material 12. The latter material is indicated presently in the form of two concentric plies of prepregs (in actual fact they are implemented as overlapping one another with one or more plies), which are laminated over or wound around the functional layer 6. At its inside 14, the main body 10 is connected firmly to an outside 16 of the functional layer 6.

FIG. 1 shows the pipe 2 while a process for its production is being implemented. Accordingly, the arrangement composed of the functional layer 6 and the main body 10 is applied on a radially internal core 18, which likewise extends along the central longitudinal axis 4. The core is fabricated from a sleeve 30 composed of plastic with a metal reinforcement 32 in the interior for improving the dimensional stability.

The overall arrangement composed of the core 18, the functional layer 6 and the main body 10 is surrounded radially externally by a shrink tube 20.

The pipe 2 or the functional layer 6 radially internally has an inner wall 22, with which the pipe 2 surrounds an interior 24 within the pipe 2. The pipe 2 is equipped/intended, after fabrication, i.e. when in its fabrication state FZ in its operation B, to accommodate and carry a medium 26 in its interior 24. The operation B and fabrication state FZ and also the medium 26 are to be understood as indicated only symbolically in FIG. 1; in operation B and fabrication state FZ, the core 18 and the shrink tube 20 are then removed.

In the example, all of the structures—the core 18, the functional layer 6, the main body 10 and the shrink tube 20—are circular cylinders/sheaths.

Described below is a process for producing the pipe 2.

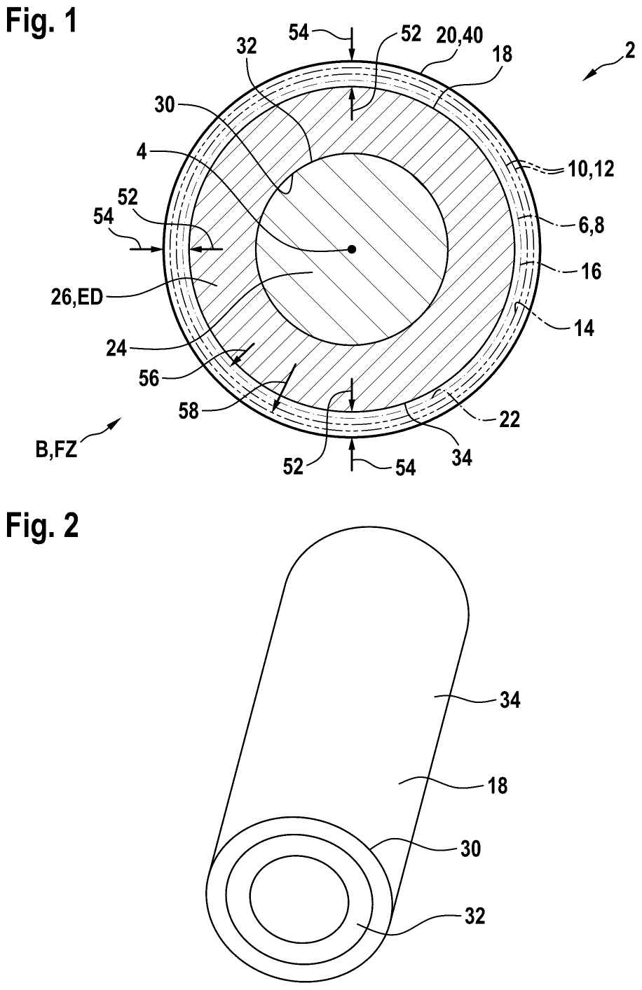

FIG. 2 in this regard shows how first the core 18 is provided. It again depicts the metallic inner core in the form of the reinforcement 32 and the outer core 30 applied radially externally to this inner core 32, in the form of the sleeve 30 composed of plastic. An outer wall 34 of the core 18 forms a bearing face for the inner wall 22 of the pipe 2 and hence for the functional layer 6 and the functional material 8.

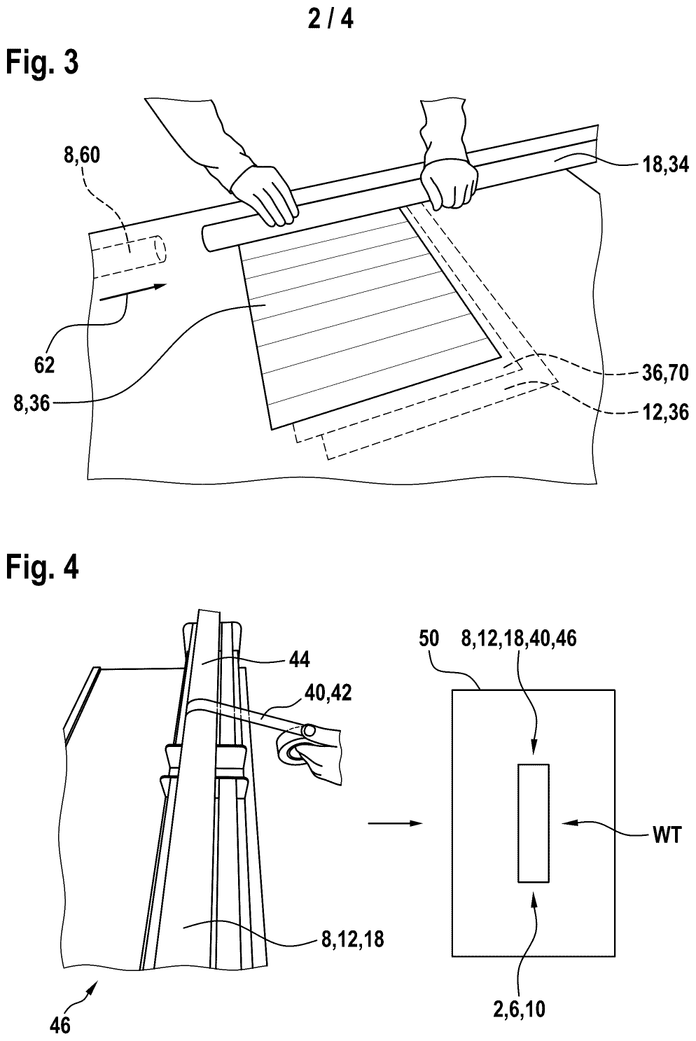

FIG. 3 shows, in the next step, the application of the functional material radially externally to the core 18 or to its outer wall 34. In this case, the functional material 8 is wound onto the core 18, as a comparatively wide (therefore more of a “cloth material”) tape material 36. This takes place manually by an individual not further elucidated, who is indicated by way of their hands.

As soon as the functional material 8 has been wound completely onto the core 18, the fiber composite material 12—here also in the form of cloth or tape material 36—is applied in the same way to the functional material 8. This takes place in the same way as just explained for the functional material 8 and is therefore indicated in dashed form in FIG. 3.

FIG. 3 also shows in dashed form an alternative for the application of the functional material 8 to the core 18, when the latter, indeed, is not wound as tape material 36 but is instead pulled on/applied to the core 18, in the direction of the arrow 62, as a pre-prepared functional tube 60.

FIG. 3 shows in dashed form how optionally a metal layer 70 is introduced into the pipe 2 during the production of the latter, specifically by the metal layer 70 being wound as tape material 36 likewise onto the core 18 or functional layer 6 or functional material 8 in an intermediate step between application of the functional material 8 and of the fiber composite material 12.

FIG. 4 shows how subsequently a shrink material 40 is radially externally applied to the fiber composite material 12 (and therefore, lying beneath, to functional material 8 and core 18). This too takes place by wrapping, in this case with a comparatively narrow and therefore less cloth-like shrink tape 42. The result of this, after complete application, is the shrink tube 20 composed of the shrink material 40, which surrounds the fiber composite material 12. The components—core 18, functional material 8, fiber composite material 12 and shrink material 40—together form a pipe arrangement 46. For the purpose of wrapping, a winding device is indicated, though not further elucidated in the figure, and the pipe arrangement is mounted in rotation in this device.

In a further step, indicated only symbolically in FIG. 4, the pipe arrangement 46 is heated to a hot temperature WT in this case in an oven 50. In the oven 50 or by means of the oven 50, then, heating to the hot temperature WT takes place. Taking place accordingly is the actual thermoforming of the pipe 2 composed of functional material 8 and fiber composite material 12 of the pipe arrangement 46. In this procedure there is radial application of pressure by functional material 8 and fiber composite material 12 against one another.

This is accomplished—indicated in FIG. 1—first by radially outward pressure 52 to the functional material 8 by radially outward thermal expansion of the core 18, indicated by arrows. And, secondly, by radially inward pressure 54 to the fiber composite material 12 by radially inward thermal contraction of the shrink tube 20, indicated by arrows.

The corresponding pressure and also the heat of the hot temperature WT in accordance with FIG. 4 lead to consolidation of the functional material 8 together with the fiber composite material 12 to give the pipe 2, containing the main body 10 and the functional layer 6 connected to it.

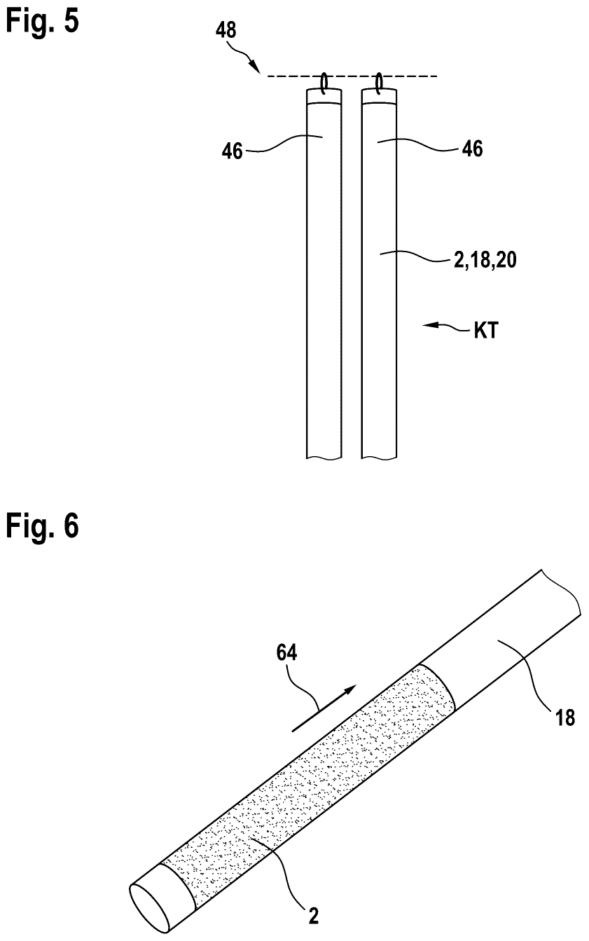

FIG. 5 shows two pipe arrangements 46 after withdrawal from the oven 50 and therefore containing completed pipes 2 on cores 18, surrounded by shrink tubes 20. The pipe arrangements 46 are then cooled down to a cold temperature KT. Also indicated are hangers 48, which serve to allow the pipe arrangements 46 to be suspended in the oven and for cooling.

The functional material 8 is selected such that—at least in the fabrication state FZ, i.e. when it has formed the functional layer 6—it has such media resistance with respect to the medium 26 indicated in FIG. 1 that it is less damaged by the medium 26, at least for a planned usage period ED, than the fiber composite material 12 or the main body 10 would theoretically or hypothetically be damaged if it were equally exposed to the medium 26. The different extents of damage are represented symbolically in FIG. 1 by different-sized arrows 56 (comparatively little damage to functional layer 6) and 58 (comparatively high level of notional damage to main body 10).

FIG. 6 shows the following: provided as core 18 in FIG. 2 is a core which in terms of its outer wall 34 or its diameter, has a greater radial thermal contraction between hot temperature WT and cold temperature KT than the pipe 2 or its internal diameter at the inner wall 22. As a result of this, the core 18 can be easily pulled out of the fabricated pipe 2, in the direction of the arrow 64 from the pipe 2.

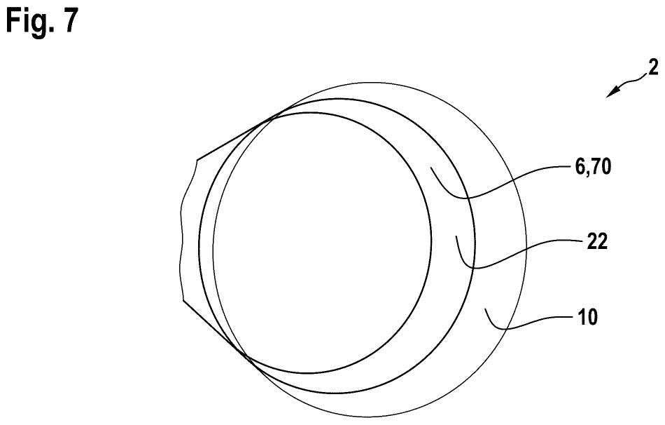

FIG. 7, finally, as an alternative to FIG. 3, shows in symbolically indicated form how, after the production of the pipe 2 fabricated to this point, the metal layer 70 is introduced, by the functional layer 6 being metallized—that is, coated metallically. Here, strictly speaking, the metal layer 70, which is understood here as part of the functional layer 6, forms the inner wall 22 of the pipe 2.

The following is a summary list of reference numerals and the corresponding structure used in the above description of the invention:
2 pipe
4 central longitudinal axis
6 functional layer
8 functional material
10 main body
12 fiber composite material
14 inside (main body)
16 outside (functional layer)
18 core
20 shrink tube
22 inner wall (pipe)
24 interior (pipe)
26 medium
30 sleeve
32 reinforcement
34 outer wall (core)
36 tape material
40 shrink material
42 shrink tape
46 pipe arrangement
48 hanger
50 oven
52 pressure (radially outward, core)
54 pressure (radially inward, shrink tube)
56 arrow (damage to functional layer)
58 arrow (notional damage to main body)
60 functional tube
62 arrow (application of functional tube)
64 arrow (extract of core)
70 metal layer
B operation
FZ fabrication state
WT hot temperature
KT cold temperature
ED usage period

1. A process for producing a pipe extending along a central longitudinal axis and having a tubular main body composed of a fiber composite material and the tubular main body having an inside firmly connected to a tubular functional layer composed of a functional material and the tubular function layer having an inner wall surrounding an interior of the pipe, the pipe in a fabricated state being intended to accommodate a defined medium in the interior, which comprises the steps of:
providing a core extending along the central longitudinal axis and having an outer wall forming a bearing face for the inner wall of the tubular functional layer;
applying the functional material radially externally to the core;
applying the fiber composite material radially externally to the functional material;
applying a shrink material, which at least in a course of the process forms a shrink tube, radially externally to the fiber composite material;
thermoforming the pipe by:
heating the core, the functional material, the fiber composite material and the shrink material to a hot temperature;
at a same time, applying pressure radially against one another by a radially inward pressure to the fiber composite material and a radially outward pressure to the functional material:
by radially inward thermal contraction of the shrink tube; and/or
by radially outward thermal expansion of the core;
at a same time, consolidating the functional material together with the fiber composite material to define a consolidated pipe with the functional layer and the tubular main body;
cooling the consolidated pipe to a cold temperature and demolding the consolidated pipe from the shrink tube and from the core; and
selecting the functional material such that at least in the fabricated state the consolidated pipe has such media resistance with respect to a medium that at least for a planned usage period the consolidated pipe is less damaged by the medium than the fiber composite material if the fiber composite material were to be equally exposed to the medium.

2. The process according to claim 1, wherein on radially external application to the core, the functional material is already in a form of a completed functional tube.

3. The process according to claim 1, which further comprises applying the functional material radially externally to the core by being wound onto the core.

4. The process according to claim 1, which further comprises applying the fiber composite material radially externally to the functional material by being laminated over and/or wound round.

5. The process according to claim 1, which further comprises applying the shrink material radially externally to the fiber composite material by being wound round.

6. The process according to claim 1, wherein the core has an outer wall, the core in relation to the outer wall has a greater radial thermal contraction between hot temperature and the cold temperature than the consolidated pipe.

7. The process according to claim 1, wherein during a production of the pipe:
introducing a metal layer as part of the tubular functional layer into the pipe; and/or
before, during or after production, metallizing the tubular functional layer to form the metal layer.

8. A pipe, comprising:
a tubular main body extending along a central longitudinal axis, composed of a fiber composite material, and having an inside wall; and
a tubular functional layer composed of a functional material and having an inner wall, said inner wall of said tubular functional layer surrounding and defining an interior of the pipe, the pipe being intended to accommodate a defined medium in said interior, said tubular functional layer is firmly connected to said inside wall of said tubular main body, wherein said functional material is consolidated together with said fiber composite material to form the pipe, wherein said functional material is selected such that at least in a fabricated state said functional material has such media resistance with respect to the defined medium that at least for a planned usage period said functional material is less damaged by the defined medium than said fiber composite material if said fiber composite material were to be equally exposed to the defined medium.

9. The pipe according to claim 8, wherein the pipe which in operation carries the defined medium in a form of coolant in a cooling circuit of a fuel cell or the defined medium in a form of hydrogen of the fuel cell.
